(19) United States
(12) Patent Application Publication
(10) Pub. No.: US 2010/0260171 A1
(43) Pub. Date: Oct. 14, 2010

(54) METHOD AND APPARATUS FOR PROCESSING NUMBER PORTABILITY IN INTERNET PHONE

(76) Inventors: Young Sic Jeong, Daejeon (KR); Chang Min Park, Daejeon (KR); Hong Seok Jeon, Daejeon (KR)

Correspondence Address: Jae Y. Park, Kile, Goekjian, Reed & McManus, PLLC, 1200 New Hampshire Ave. NW, Suite 570, Washington, DC, 20036, US

(21) Appl. No.: 12/745,984

(22) PCT Filed: Nov. 26, 2008
(86) PCT No.: PCT/KR08/06960

§ 371 Date: Jun. 3, 2010

(30) Foreign Application Priority Data
Dec. 4, 2007 (KR) 10-2007-0125146

(51) Int. Cl. H04L 12/66

(52) U.S. Cl. 370/352

(57) ABSTRACT

The present invention relates to a method and apparatus for processing a number portability call and a request for number portability in a VoIP, wherein a VoIP network access to a L-NPDB of each communication carrier to process the number portability call. Especially, to process a number portability call and request for number portability between various types of communication network such as VoIP networks, wired phone network, and mobile network, the apparatus includes an mobile number portability management system comprised of computer systems such as an NPDB, DB system where a VoIP carrier accesses, a router, an NPMS, and the like, a computer system of a VoIP network which can access and search the NPDB to process a phone call in VoIP network or can performs a relay-access of the phone call, and a switch board.

### TECHNICAL FIELD

The present invention relates to a method and apparatus for processing a number portability call, particularly, to a method and apparatus for processing a number portability call and request for number portability in Internet phones utilizing voice over Internet Protocol (VoIP).

This work was supported by the IT R&D program of MIC/IITA. [2007-P10-39, Development of Standard Technique for implementing number portability]

### BACKGROUND ART

Number portability is a function that enables a telecommunication service subscriber to keep a current phone number even when the subscriber changes telecommunication carriers, a service providing location, or a type of service, most other countries consider carrier portability to be the same as the number portability. That is, the number portability is a service where a wire/wireless communication subscriber can freely change telecommunication carriers without changing its number. For example, when Hong, Gil-Dong who is a subscriber of SK telecommunication, changes his telecommunication carrier from the current carrier, SK telecommunication, to LG telecommunication, he can use his original number.

The Internet phone (VoIP), which transmits circuit-switched voice data through a packet-switching IP-based data network, such as a local area network (LAN), a wide area network (WAN), a Virtual Private Network (VPN) and the common Internet, generally is operated in a PC-PC scheme, a PC-to-phone scheme, or a phone-to-phone scheme. Since the system is practicable when an originating network and a recipient network are connected by means of a mode No. 7 intelligent network, when processing a number portability between VoIPs, an Internet protocol has to be converted into the No. 7 protocol. In this instance, since a method for converting number portability information from the No. 7 protocol to a VoIP protocol is not defined, there is a problem that processing of a number portability call is impossible.

Also, a method for renewing and processing a request from a client for number portability between various telephone networks in real-time is required.

### DISCLOSURE OF INVENTION

### Technical Goals

The present invention is disclosed to solve the above-described problems of a conventional art. An aspect of the present invention provides a method for processing a request from a client for processing a number portability call in real-time using a mobile number portability customer relationship management (M-NP CRM) system together with processing a number portability call using an Internet protocol and a local number portability database (L-NPDB) which VoIP network carriers respectively establish to process a number portability call.

Another aspect of the present invention also provides a method for effectively processing a request for number portability between Internet phones (VoIPs) using an M-NP CRM system, and a method for processing a number portability call between VoIPs by mutual connecting using an Internet protocol without converting into No. 7 protocol.

Another aspect of the present invention also provides a more effective method for processing a number portability call and for renewing a Mobile database (DB) to improve a conventional method for processing a request for number portability.

### Technical Solutions

According to an aspect of the present invention, there is provided a method for processing a number portability call between Internet phones (VoIPs), includes: receiving a call-setup request from an originating network for a certain Dialed Number (DN) of a donor network, verifying whether the DN is a number with number portability in response to the call-setup request, and transmitting number portability information to the originating network, when the DN is verified as the number with number portability, the number portability information being used when the originating network verifies whether the DN is the number with number portability, wherein the originating network verifies a Routing Number (RN) of a recipient network using a local number portability database (L-NPDB), routes the call to the recipient network using the DN and RN, and sets up the call to the recipient network, when the originating network verifies whether the DN is the number with number portability.

According to an aspect of the present invention, there is provided an apparatus for processing M-number portability, includes: a report generator to generate a report for number portability according to a request from a recipient network for number portability, a second router to transmit the report generated from the report generator to an NPMS, the NPMS to forward the transmitted report from the second router to a donor network of a donor, and transmit a response to the forwarding to a recipient network of a recipient, an Mobile number portability database (M-NPDB) to renew data of the NPMS, necessary for processing a number portability, to store the data in the NPMS, and to provide information necessary for routing a phone call, and a first router to transmit information stored in the M-NPDB to at least one L-NPDB of telephone network operators.

### BRIEF DESCRIPTION OF DRAWINGS

FIG. 1 is a configuration diagram illustrating a method for processing a number portability call according to an example embodiment of the present invention;

FIG. 2 illustrates a method for processing a number portability call between VoIP terminals (when interlocked with a H.323) according to an example embodiment of the present invention;

FIG. 3 illustrates a method for processing a number portability call between VoIPs (when interlocked with a Session Initiation Protocol (SIP)) according to an example embodiment of the present invention;

FIG. 4 illustrates a method for processing a number portability call between VoIPs (when interlocked with a No. 7) according to an example embodiment of the present invention;

FIG. 5 illustrates a method for renewing a local number portability database (L-NPDB) in real-time using a Mobile number portability database (M-NPDB) according to an example embodiment of the present invention;

FIG. 6 is a configuration diagram illustrating a method for processing a request for Mobile Number Portability (MNP) according to an example embodiment of the present invention; and

FIG. 7 is a flowchart illustrating a method for processing a number portability call according to an example embodiment.

### BEST MODE FOR CARRYING OUT THE INVENTION

The embodiments of the present invention are described below by referring to the figures, and when an example embodiment makes the subject matter of the present invention unnecessarily vague, detailed description thereof is omitted.

When detailed descriptions related to a well-known related function or configuration are determined to make the spirits of the present invention ambiguous, the detailed descriptions will be omitted herein. Also, terms used throughout the present specification are used to appropriately describe exemplary embodiments of the present invention, and thus may be different depending upon a user and an operator's intention, or practices of application fields of the present invention. Therefore, the terms must be defined based on descriptions made through the present invention

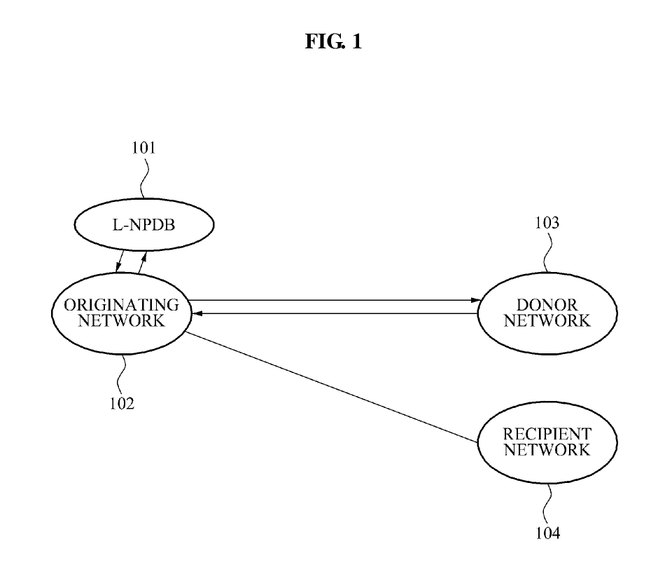

FIG. 1 is a configuration diagram illustrating a method for processing a number portability call according to an example embodiment of the present invention.

Hereinafter, terms and fundamental notions for processing a number portability call according to an example embodiment are described referring to FIG. 1.

The processing of number portability call includes a local number portability database (L-NPDB) 101, an originating network 102, a donor network 103, a recipient network 104, and the like, and an embodiment thereof is as follows.

First, voice communication through the Internet began in 1995 when Vocltec Communication Inc. introduced an Internet phone. Software of Vocaltec Communication Inc., which compresses a voice signal, converts the signal into an Internet protocol (IP) packet, and transmits the packet through the Internet, specifically a PC-to-PC scheme, has a problem in that a recipient and transmitter should access at the same time and use the same software. Since then, Internet phones have been rapidly developed. Recently, PC-to-Phone and Phone-to-Phone is possible with a gateway through which an analog voice signal is converted into an IP packet and vice versa, the gateway being an interface between the Internet and public switched telephone network (PSTN).

Fundamental terms related to a number portability service include “originating network”, “donor network”, and “recipient network”. An originating network 102 indicates a communication carrier network of an sender(*caller), a donor network 103 indicates a communication carrier network where a recipient had been enrolled in prior to number migration, and a recipient network 104 indicates a final communication carrier network where the recipient belongs after the number migration. For example, when A who is a subscriber of SK telecommunication calls B who changes communication carrier networks from SK telecommunication to LG telecommunication with B's original number, the originating network is SK telecommunication network, the donor network is SK telecommunication network which B used to use, and the recipient network is LG telecommunication network which B now uses.

The number portability service is roughly classified into a Local Number Portability (LNP) and Mobile Number Portability (MNP). As a representative method of the LNP, number portability process methods that mobile communication carriers mainly use are Query on Release (QoR) and All Call query (ACQ).

First, the QoR is a method that when, as an example, a call is made to a subscriber with an identification number ‘016 ’, the call is first transmitted to KTF, and when the KTF verifies that the call is not from a subscriber of KTF, an NPDB is searched and the call is transmitted to a carrier where the subscriber actually belongs.

According to the QoR method, the call is transmitted to the carrier which initially assigns the identification number, without verifying whether the number of the subscriber is a number with number portability. That is, the call is first transmitted to a donor network, and when a recipient is a number portability subscriber, ‘number portability’ information is returned to an originating network, then the call is released, and finally, the originating network which receives the information queries a number portability subscriber database and connects the call to the recipient network.

Thus, when there are many number portability subscribers, network traffic is increased and call processing rate is decreased in proportion to the increase in traffic.

ACQ method is a method where, unlike QoR method, an NPDB is initially searched to verify whether a number is a number with number portability, and a call is then transmitted to a corresponding carrier. That is, in the processing of a number portability call, an originating network queries a number portability subscriber database for every call and routes the call to the recipient network.

Since ACQ omits a step of transmitting of a call to a carrier which initially assigns an identification number, ACQ may decrease traffic and a call processing rate is increased when there are a lot of number portability subscribers.

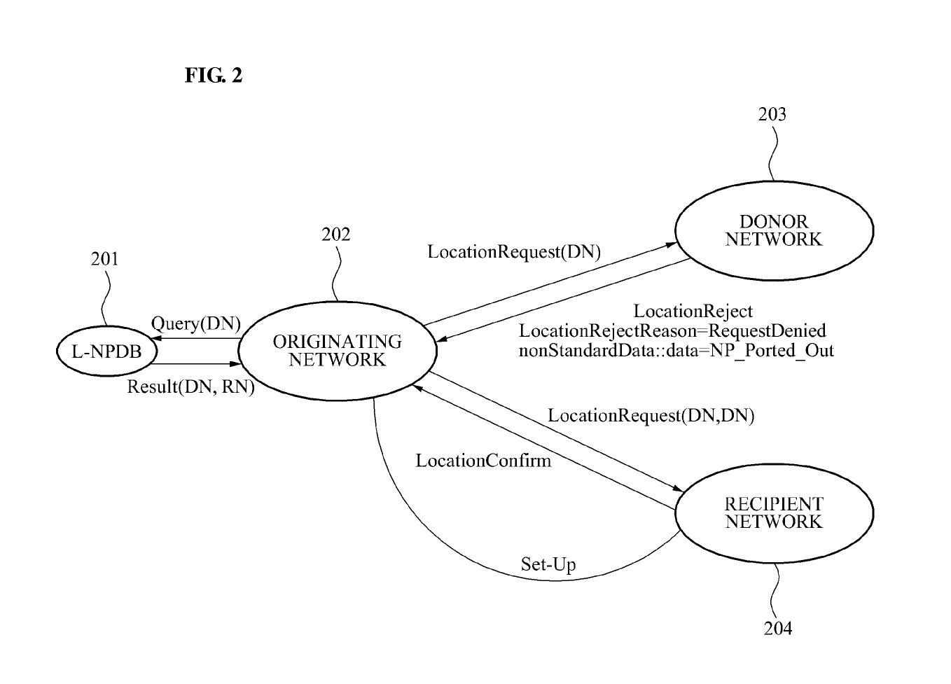

FIG. 2 illustrates a method for processing a number portability call between VoIP terminals (when interlocked with a H.323 protocol) according to an example embodiment of the present invention;

Hereinafter, a method for processing a number portability call between VoIPs (when interlocked with the H.323 protocol) according to an example embodiment of the present invention is described referring to FIG. 2.

The method (*A system for processing a number portability call between VoIPs includes an L-NPDB 201, originating network 202, donor network 203, and recipient network 204, and an embodiment thereof is as following. When the originating network 202, donor network 203 and recipient network 204 are connected by means of the H.323 protocol, since a method for transferring number portability information is not defined in the H.323 protocol, the processing of a number portability call is embodied as described below.

The originating network 202 request a LocationRequest to the donor network 203 using a Dialed Number (DN), and the donor network 203 searches an internal database (DB), and sets, when the DN is a number with number portability, a LocationRejectReason field to a RequestDenied and nonStandardData field to an NP_Ported_Out so as to transmit a LocationReject message which indicates that the DN is a number with number portability to the originating network 202. When the LocationReject message is received, the originating network 202 checks the LocationRejectReason field and nonStandardData field, and, when RequestDenied and NP_Ported_Out are identified from the fields, considers the DN as a number portability call. Next, the originating network 202 sends a query for the DN to the L-NPDB to verify a Routing Number (RN) of the recipient network 204, and routes the call to the recipient network 204 using the RN and DN. That is, the originating network 202 sends the LocationRequest message to the recipient network 204 using the RN and DN, and the recipient network 204 sends a LocationConfirm message to the originating network 202, thereby setting up the call.

In addition, for reference, the setting of a nonStandardData filed to NP_Ported_Out is one example of converting a value of a non-standard data field into an off-status, and although one example of the present invention is described herein, the present invention is not limited to the described example, and is defined based on the claims.

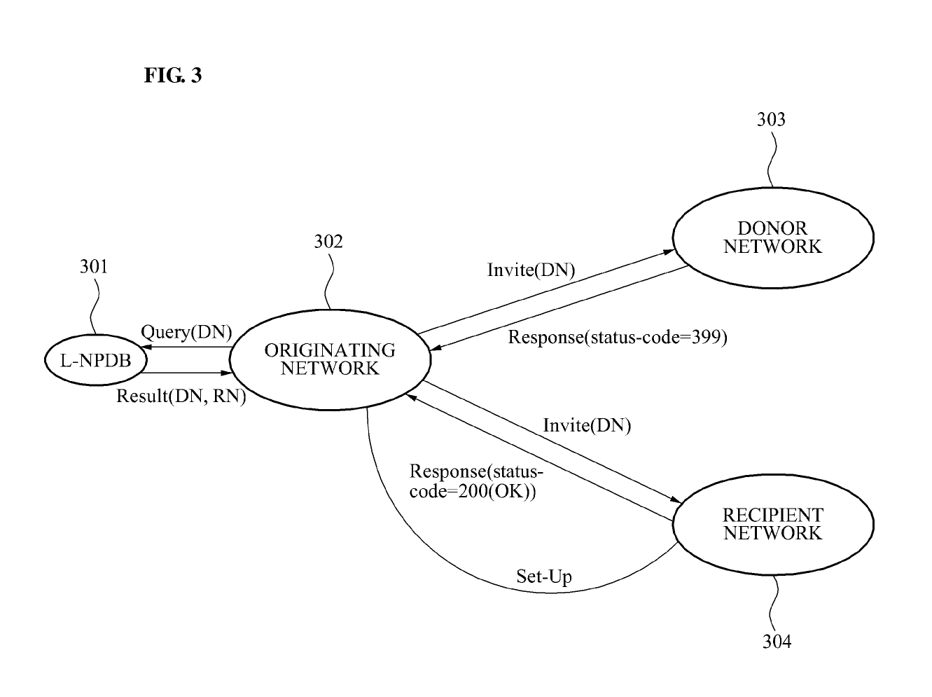

FIG. 3 illustrates a method for processing a number portability call between VoIPs (when interlocked with an SIP) according to an example embodiment of the present invention.

Hereinafter, the method for processing a number portability call between VoIPs (when interlocked with the SIP) according to an example embodiment of the present invention is described referring to FIG. 3.

A system for processing a number portability call includes an L-NPDB 301, an originating network 302, a donor network 303, and a recipient network 304, and an embodiment thereof is as follows.

When the originating network 302, the donor network 303, and the recipient network 304 are connected via the SIP protocol, since a method for transferring number portability information is not defined in the SIP protocol, the processing of a number portability call is embodied as described below.

The originating network 302 sends a call-setup message, specifically, an Invite message, to the donor network 303 using DN, and, when the DN is a number with number portability, the donor network 203 sends a Response message, specifically a value of a status-code of which is set to “399”, to the originating network 302. When the status-code of the Response message is “399”, the originating network 302 considers the DN as a number with number portability, sends a query to the L-NPDB 301 to obtain an RN of the recipient network 304, and sends the Invite message to the recipient network 304 using the RN and DN. If the recipient network sets a value of the status-code to “200” when transmitting the Response message, a session between the originating network 302 and the recipient network 304 is connected to process the number portability call.

In addition, for reference, the value “399” is one example of specific numerical values, and although one example of the present invention is described herein, the present invention is not limited to the described example, and defined based on the claims.

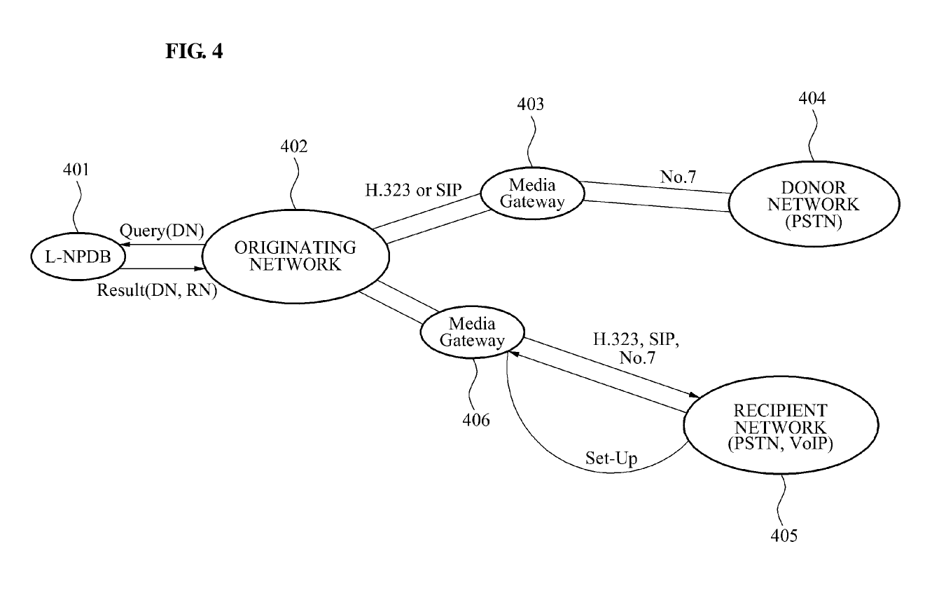

FIG. 4 illustrates a method for processing a number portability call between a VoIP and a wired phone (when interlocked with a No. 7) according to an example embodiment of the present invention.

Hereinafter, the method for processing a number portability call between a VoIP and a wired phone (when interlocked with the No. 7) according to an example embodiment of the present invention is described referring to FIG. 4.

A system for processing a number portability call includes an L-NPDB 401, a originating network 402, Media Gateways 403 and 406, a donor network 404, a recipient network 405, and the like, and an embodiment thereof is as follows.

The processing of the number portability call between the VoIP and wired phone (when interlocked with the No. 7) according to the present invention is a method for processing a number portability call when a call is made from the VoIP network to a general wired phone network. When a call is made from the originating network 403(*402 to the donor network 404 and the originating network 402 is a VoIP phone carrier using either a H.323 or SIP protocol, the Media Gateway 403 should be equipped to convert either the H.323 or SIP protocol into the No. 7 signal network scheme in order to make a call to a donor network being a general wired phone network. Also, a No. 7 message from the donor network 404 should be converted into the either the H.323 or SIP protocol. In this instance, a flow of the processing of the number portability call is as follows.

When a call is generated from the VoIP originating network 402, the call is converted into No. 7 signal and transmitted to the donor network 404 through the Media Gateway 403, and the donor network 404 searches an internal customers DB and, when a DN is a number with number portability, sends a Release message to the originating network 402 together with a value indicating a cause as “number portability”.

The message is translated into either an H.323 message or SIP message at the Media Gateway 403 and transmitted to the originating network 402. In this instance, when the originating network 402 uses the H.323 protocol, a LocationReject message, wherein a LocationRejectReason field is set to a RequestDenied and a nonStandardData field is set to an NP_Ported_Out, is transmitted, and when the originating network 402 uses the SIP protocol, the Media Gateway 403 transmits a Response message, wherein a value of a status code is set to “399”, to the originating network 402.

Subsequently, when the originating network 402 uses the H.323 protocol, the LocationRejectReason field and the nonStandardData field in the LocationReject message are checked. When the fields are respectively set to the RequestDenied and NP_Ported_Out, the DN is considered as a number with number portability, thereby sending a query to the L-NPDB 401. After obtaining an RN of the recipient network 405 through the query, the call is routed to the recipient network 405 through the Media Gateway 406 using the RN and DN. Therefore, the call from the VoIP originating network 402 to the wired phone network 404 is connected to the recipient network 405 through the processing of number portability.

An apparatus for processing of a number portability call between VoIPs includes an L-NPDB to store at least one of a RN of a number probability subscriber prior to a migration, a RN after the migration, a DN prior to the migration, a DN after the migration, and personal information, and an originating network controller to request a call-setup for a certain DN to a donor network, to verify whether the DN is a number with number portability, to verify an RN of a recipient network through the L-NPDB using the number, and to route a call to the recipient network, a donor network controller to verify whether the number for the requested call-setup is a number with number portability in response to the call-setup request of the originating network controller, and to transmit, when the number for call-setup requested is verified as the number with number portability, number portability information to the originating network, and a recipient network controller to set up a call according to routing of the originating network controller.

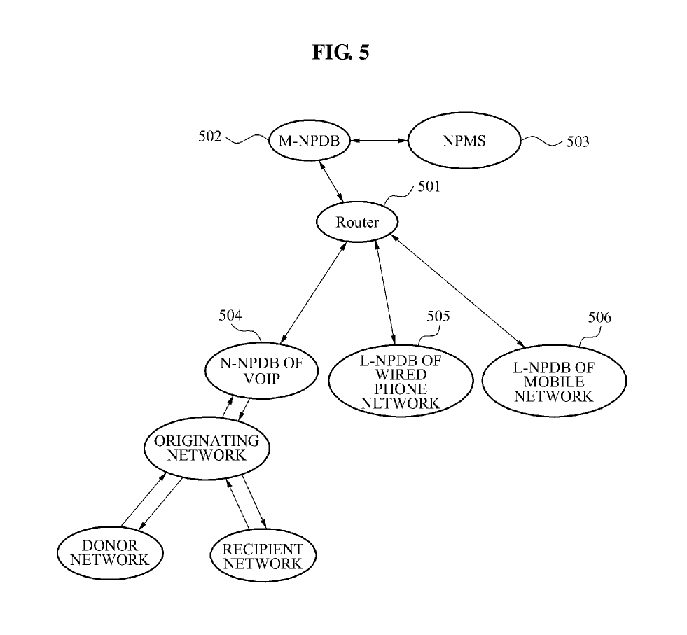

FIG. 5 illustrates a method for renewing an L-NPDB in real-time using an M-NPDB according to an example embodiment of the present invention.

Hereinafter, a method for renewing an L-NPDB in real-time using an M-NPDB according to an example embodiment of the present invention is described referring to FIG. 5.

The method for renewing of the L-NPDB in real-time using the M-NPDB, which is a method for updating the L-NPDB with any changes in the M-NPDB in real-time, includes L-NPDBs 504, 505 and 506 of the wired/wireless communication carrier, a router 501 connected to the L-NPDBs by means of a dedicated line, an M-NPDB 502 connected to the router, and an NPMS 503 connected to the M-NPDB.

According to the renewing of the M-NPDB in real-time using the M-NPDB, the NPMS 503 processes a request of a subscriber for a number portability, and when the processing is completed, information necessary for routing a phone call is stored in the M-NPDB 502. Then, the M-NPDB 502 immediately transmits the information to at least one of L-NPDBs 504, 505, and 506 of telephone network operators. Accordingly, the L-NPDB may immediately updates changed data and use the same when processing a number portability call.

In particular, transmission between the M-NPDB 502 and the L-NPDBs 504, 505, and 506 is performed more reliably, simply, and accurately by using Common Object Request Broker Architecture (CORBA).

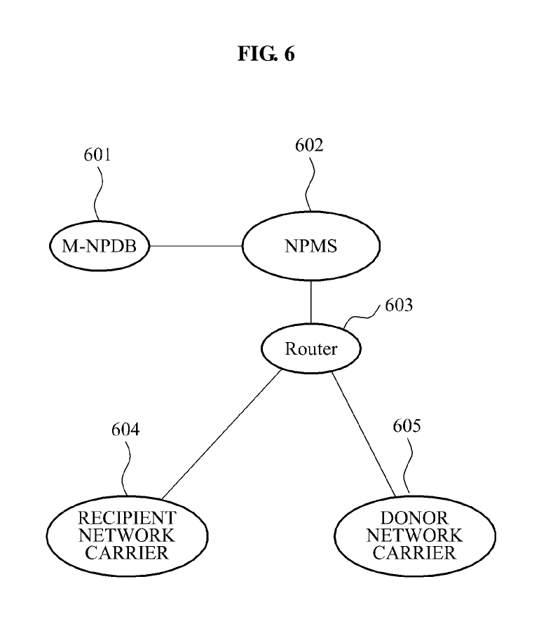

FIG. 6 is a configuration diagram illustrating a method for processing a request for an MNP according to an example embodiment of the present invention.

Hereinafter, the notion of processing a request for an MNP according to an example embodiment of the present invention is described referring to FIG. 6.

The method for processing of the M-request for number portability according to an example embodiment, which is a method for processing the request and updating a result of the processing to the M-NPDB, includes an M-NPDB 601, an NPMS 602 interlocked with the M-NPDB 601, a Router 603 connected to the NPMS 602, a plurality of recipient network carrier 604 connected to the Router 603, and a plurality of donor network carrier 605. In this instance, a flow where the NPMS processes a request of a subscriber for number portability call is as follows.

When a subscriber desiring number portability visits an agency of the recipient network to request number portability, the agency generates a report for number portability and transmits the same to the NPMS 602 through the Router 603. When the report is received, the NPMS 602 forwards the report to the donor network carrier 605 and transmits, to the recipient network 604, a donor network carrier's response to the forwarding.

When the processing of the request for number portability is completed, the NPMS 602 stores information necessary for processing of a number portability call in the M-NPDB 601. The M-NPDB updates L-NPDBs 504, 505, and 506 of all communication carriers through the processes in FIG. 5 and thus the L-NPDB uses the same when processing a number portability call.

An apparatus for processing M-number portability, which is operated as described above, includes a report generator to generate a report for number portability according to a request from a recipient network for number portability, a second router to transmit the report generated from the report generator to an NPMS, the NPMS to forward the transmitted report from the second router to a donor network of a donor network carrier and to transmit a response to the forwarding to a recipient network of a recipient, an M-NPDB to renew data of the NPMS, necessary for processing a number portability, to store the data in the NPMS, and to provide information necessary for routing a phone call, and a first router to transmit information stored in the M-NPDB to at least one L-NPDB of telephone network operators.

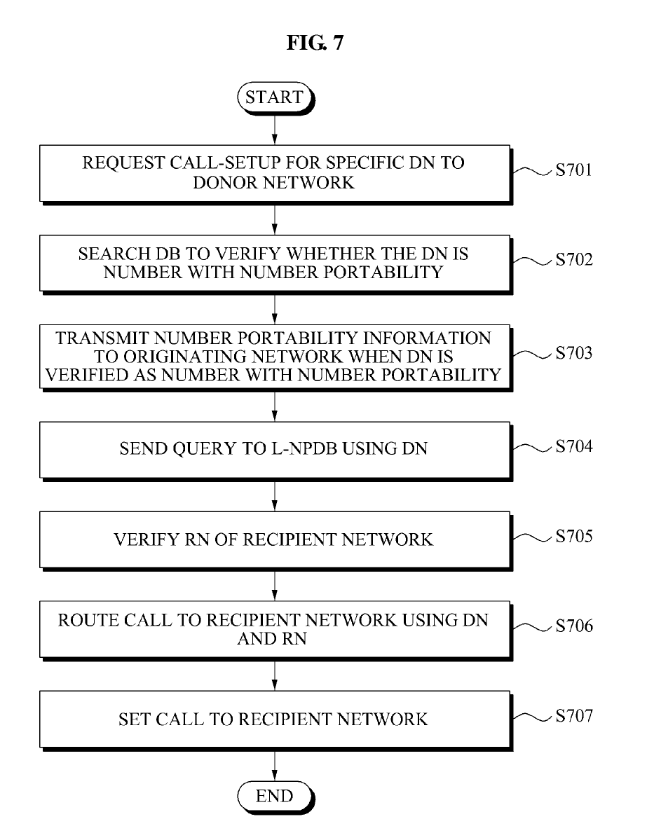

FIG. 7 is a flowchart illustrating a method for processing a number portability call according to an example embodiment.

When a VoIP service call is generated, whether a DN is subscribed to a communication network where the recipient number is received is verified and when the number is subscribed, a corresponding VoIP terminal is called and a telephone call service is provided. However, when the number is not subscribed, call-setup for the specific recipient number is requested.

In this instance, when the recipient number is a number with number portability, the method for processing of number portability call according to the present invention is used. In the method, when an originating network requests call-setup for a specific DN to a donor network in operation S701, the donor network searches an internal DB and verifies whether the number is a number with number portability in response to the request in operation S702.

As a result of the verifying, the donor network transmits number portability information to the originating network in operation S703 when the number for call-setup requested is a number with number portability. In this instance, a LocationRejectReason is set to a RequestDenied and a nonStandardData is set to an NP_Ported_Out so as to transmit a LocationReject message which indicates that the number is a number with number portability to the originating network.

When the LocationReject message is received, the originating network checks the LocationRejectReason field and nonStandardData field, and when RequestDenied and NP_Ported_Out are identified from the fields, considers the DN as a number portability call in operation S704.

Next, the originating network sends a query for the DN to the L-NPDB to verify a RN of the recipient network in operation S705, and sends a LocationRequest message to the recipient network using the RN and DN to route the call in operation S706. Subsequently, the recipient network sends a LocationConfirm message to the originating network, thereby setting up the call in operation S707.

According to the present invention, there is provided a method for effectively processing a number portability call even when using either an H.323 or SIP, and decreasing a time consumption when processing a number portability by effectively processing a request from a subscriber for number portability and renewing a L-NPDB in real-time, whereas a conventional system for processing a number portability call only processes No. 7 protocol.

The method for processing a number portability call and a request for number portability in VoIP according to the above-described example embodiments of the present invention may be recorded computer-readable media including program instructions to implement various operations embodied by a computer. The media may also include, alone or in combination with the program instructions, data files, data structures, and the like. The program instructions may be those specially designed and constructed for the purposes of example embodiments, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

1. A method for processing a number portability call between Internet phones utilizing voice over Internet Protocol (VoIP), comprising:
receiving a call-setup request from an originating network for a certain Dialed Number (DN) of a donor network;
verifying whether the DN is a number with number portability in response to the call-setup request; and
transmitting number portability information to the originating network, when the DN is verified as the number with number portability, the number portability information being used when the originating network verifies whether the DN is the number with number portability,
wherein the originating network verifies a Routing Number (RN) of a recipient network using a local number portability database (L-NPDB), routes the call to the recipient network using the DN and RN, and sets up the call to the recipient network, when the originating network verifies whether the DN is the number with number portability.

2. The method of claim 1, wherein when VoIP networks comprise of the originating network, donor network, and recipient network and use an H.323 protocol, the transmitting comprises:
setting up a LocationRejectReason value in a LocationReject message field as a RequestDenied; and
converting a non-standard data value into an off-status.

3. The method of claim 1, wherein when VoIP networks comprise of the originating network, donor network, and recipient network are comprised and use a Session Initiation Protocol (SIP) protocol, the transmitting comprises:
setting a status-code value of a Response message to a specific numerical value.

4. The method of claim 1, wherein when the originating network is a VoIP network, and the donor network is a general wired phone network, further comprises:
transmitting, when a call is generated, the number portability information using a gateway between the originating network and the donor network or between the originating network and the recipient network.

5. The method of claim 4, wherein the transmitting comprises:
converting the scheme of the number portability information from a No. 7 signal to either an H.323 protocol or an SIP protocol.

6. The method of claim 1, wherein when the originating network is a general wired phone network, and the donor network is a VoIP network, further comprises:
transmitting, when a call is generated, the number portability information using a gateway between the originating network and the donor network or between the originating network and the recipient network.

7. The method of claim 6, wherein the transmitting comprises:
converting the scheme of the number portability information from either an H.323 protocol or SIP protocol to a No. 7 signal.

8. A method for processing a request for a number portability between VoIPs, comprising:
processing, by a Number Portability Main Server (NPMS), a request of a number portability of a subscriber;
storing, when the processing is completed, information necessary for routing a phone call in a Mobile-Number Portability Main Server (M-NPDB); and
transmitting the information stored in the M-NPDB to at least one local number portability database (L-NPDB) of telephone network operators through a first router.

9. The method of claim 8, wherein the processing comprises:
generating a report for the number portability in response to the request from a recipient network for the number portability;
transmitting the generated repot to the NPMS through a second router;
forwarding, by the NPMS, the report to a donor network of a donor network carrier;
transmitting, by the NPMS, a response to the forwarding to a recipient network of a recipient; and
storing, by the NPMS, data necessary for processing a number portability call to the M-NPDB.

10. An apparatus for processing a number portability call between VoIPs, comprising:
an L-NPDB to store at least one of a RN of a number probability subscriber prior to a migration, a RN after the migration, a DN prior to the migration, a DN after the migration, and a personal information;
an originating network controller to request a call-setup for a certain DN to a donor network, to verify whether the DN is a number with number portability, to verify an RN of a recipient network through the L-NPDB using the number, and to route a call to the recipient network;
a donor network controller to verify whether the number for call-setup requested is a number with number portability in response to the call-setup request of the originating network controller, and to transmit, when the number for call-set-up requested is verified as the number with number portability, number portability information to the originating network; and
a recipient network controller to set up a call according to routing of the originating network controller.

11. An apparatus for processing M-number portability, comprising:
a report generator to generate a report for number portability according to a request from a recipient network for number portability;
a second router to transmit the report generated from the report generator to an NPMS;
the NPMS to forward the transmitted report from the second router to a donor network of a donor network carrier, and transmit a response to the forwarding to a recipient network of a recipient;
an M-NPDB to renew data of the NPMS, necessary for processing a number portability, to store the data in the NPMS, and to provide information necessary for routing a phone call; and
a first router to transmit information stored in the M-NPDB to at least one L-NPDB of telephone network operators.
